(19) United States
(12) Patent Application Publication
(10) Pub. No.: US 2026/0009447 A1
(43) Pub. Date: Jan. 8, 2026

(54) MOTOR MOUNT FOR AN ELECTRIC VEHICLE

(71) Applicants: HYUNDAI MOTOR COMPANY, Seoul (KR); KIA CORPORATION, Seoul (KR); PYUNG HWA INDUSTRIAL CO., LTD., Daegu (KR)

(72) Inventors: Jae Hyung Yun, Hwaseong-si (KR); Gu Gyun Kwon, Hwaseong-si (KR); Young Deuk Seo, Hwaseong-si (KR); Byeong Gon Lee, Daegu (KR)

(73) Assignees: HYUNDAI MOTOR COMPANY, Seoul (KR); KIA CORPORATION, Seoul (KR); PYUNG HWA INDUSTRIAL CO., LTD., Daegu (KR)

(21) Appl. No.: 18/937,806

(22) Filed: Nov. 5, 2024

(30) Foreign Application Priority Data
Jul. 4, 2024 (KR) 10-2024-0088067

(51) Int. Cl. F16F 15/08; B60K 1/00; F16F 1/387

(52) U.S. Cl. CPC F16F 15/08; B60K 1/00; F16F 1/387; F16F 2228/066

(57) ABSTRACT

A motor mount for an electric vehicle includes: an inner pipe having a fastening hole provided on the inner side and configured to be fastened to a load input point of a vehicle body; an outer pipe configured to be arranged coaxially with the inner pipe on the outer side of the inner pipe; an insulator configured to be coupled between the inner pipe and the outer pipe and provided with a rubber flap configured to reduce vibration transmitted through the inner pipe; and a pair of flap dampers fixedly coupled to the inside of the insulator and configured to reduce vibration in a set target high-frequency band transmitted through the inner pipe.

### CROSS REFERENCE TO RELATED APPLICATION

The present application claims priority to Korean Patent Application No. 10-2024-0088067, filed Jul. 4, 2024, the entire contents of which are incorporated herein by reference.

### BACKGROUND

### Technical Field

The present disclosure relates to a motor mount for an electric vehicle and, more specifically, to a motor mount for an electric vehicle that improves damping performance.

### Description of the Related Art

In general, vehicles equipped with gasoline and diesel engines that use fossil fuels cause many problems, such as environmental pollution due to exhaust fumes, global warming due to carbon dioxide, respiratory diseases due to ozone generation, and the like.

In addition, fossil fuels on Earth are limited, so they are at risk of being depleted at some point.

To address these issues, electric vehicles have been developed, such as Pure Electric Vehicles (EV), which are driven by a drive motor; Hybrid Electric Vehicles (HEV), which are driven by an engine and a drive motor; and Fuel Cell Electric Vehicles (FCEV), which are driven by a drive motor with electricity generated from a fuel cell, and the like.

Typically, a vehicle's engine is not only structurally prone to inducing vibration all the time, but it also vibrates in all directions due to various factors complexly working together, such as uneven ground while driving.

In particular, a vehicle using a gasoline engine generates rotational torque of a crankshaft as a piston operates in the order of intake, compression, explosion, and exhaust through a four-stroke cycle, and considerable vibration is generated during this process.

To insulate such vibration, an engine mount that supports a vehicle's engine is continuously being developed, and various research is being conducted with the primary goal of securing insulation against the main exciting force generated by the gasoline engine.

However, since electric vehicles using a drive motor do not have piston reciprocating motions such as explosions like vehicles using gasoline engines, the role of the motor mount should be changed in a different direction from that of the engine mount of vehicles using gasoline engines, such as insulating from shock vibration, jerk vibration, driving vibration, gear whine noise, and the like.

In particular, since an electric vehicle has motor modules on both the front and rear wheels, it exhibits up-and-down movement not only at the front like the gasoline engine but also at both the front and the rear.

To this end, motor mounts with flap structures, double insulation structures, and hydro unit structures have been used for the electric vehicles, and such motor mounts provide effects such as improving dynamic characteristics in specific sections and securing damping performance.

In this regard, conventional motor mounts may be effective in improving vibration reduction performance in the low/medium/high-frequency bands (1000 Hz or less) of an electric vehicle, but it is difficult to effectively reduce vibration in the ultra-high-frequency band, e.g., 1000 Hz or higher.

The foregoing is intended merely to aid in the understanding of the background of the present disclosure, and is not intended to mean that the present disclosure falls within the purview of the related art that is already known to those having ordinary skill in the art.

### SUMMARY

The present disclosure has been made keeping in mind the above issues occurring in the related art. The present disclosure provides a motor mount for an electric vehicle that may improve damping performance in a high-frequency band of 1000 Hz or higher by adding a flap part made of a high-strength material such as steel, aluminum, plastic, or the like. The motor mount may provide a damping effect at a specific frequency through tuning by selectively adjusting the number, thickness, length, and width of the flaps that make up the flap part, while also enabling the adjustment of the damping amount.

In order to achieve the above objective, according to one aspect of the present disclosure, a motor mount for an electric vehicle includes: an inner pipe having a fastening hole provided on an inner side and configured to be fastened to a load input point of a vehicle body; an outer pipe configured to be arranged coaxially with the inner pipe on an outer side of the inner pipe; an insulator configured to be coupled between the inner pipe and the outer pipe and provided with a rubber flap configured to reduce vibration transmitted through the inner pipe; and a pair of flap dampers fixedly coupled to an inside of the insulator and configured to reduce vibration in a set target high-frequency band transmitted through the inner pipe.

In one embodiment, the pair of flap dampers is configured to reduce vibration in the set target high-frequency band set to exceed the vibration in a high-frequency band being reduced through the rubber flap.

In another embodiment, each flap damper of the pair of flap dampers may include: a coupling part in a ring shape configured to be coupled with an outer circumferential surface of the inner pipe; a supporting part extending from the coupling part to an axial end of the insulator; and a flap part provided with a plurality of flaps protruding along a circumferential direction of the supporting part.

In one embodiment, the supporting part may be provided in a ring shape with a plurality of connecting members extending radially from the coupling part, and the flap part may be configured to face the rubber flap and protrude from the supporting part.

In one embodiment, the flap part may be configured to correspond to the target high-frequency band by adjusting a length in a width direction, a length in a height direction, and a thickness of the plurality of flaps.

In one embodiment, flaps of the plurality of flaps have a length in a width direction identical to one another, a length in a height direction identical to one another, and a thickness identical to one another.

In one embodiment, flaps of the plurality of flaps have a length in a width direction different from one another, a length in a height direction different from one another, and a thickness different from one another.

In one embodiment, the flap part may be provided to set a damping amount by adjusting the number of the flaps protruding from the supporting part.

As described above, the present disclosure may improve damping performance in a high-frequency band of 1000 Hz or higher by adding a flap part made of a high-strength material such as steel, aluminum, plastic, or the like and may have an effect that provides a damping effect at a specific frequency through tuning by selectively adjusting the number of flaps along with the thickness, length, and width of the flaps constituting the flap part, and that allows the damping amount to be adjusted simultaneously.

In addition, the present disclosure may have the effect of creating multiple natural frequencies and implementing multi-section damping by configuring the motor mount by applying a plurality of flaps, each of which has a thickness different from one another, a length different from one another, and a width different from one another, together to a single flap part.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a view showing a motor mount for an electric vehicle according to an embodiment of the present disclosure;

FIG. 2 is a view showing a flap damper for the motor mount for an electric vehicle according to the embodiment of the present disclosure;

FIG. 3 is a view showing an insulator for the motor mount for an electric vehicle according to the embodiment of the present disclosure;

FIG. 4 is a view showing a flap part for the motor mount for an electric vehicle according to the embodiment of the present disclosure; and

FIG. 5 is a graph showing vibration reduction in a target high-frequency band by the motor mount for an electric vehicle according to the embodiment of the present disclosure.

### DETAILED DESCRIPTION

Hereinafter, some embodiments of the present disclosure are described in more detail with reference to accompanying drawings.

The advantages and features of the present disclosure and the method of achieving them should become apparent with reference to the embodiments described in detail below together with the accompanying drawings.

However, the present disclosure is not limited to the embodiments disclosed below but may be implemented in various different forms, the present embodiments are provided only to make the disclosure of the present disclosure complete and to fully inform a person having ordinary knowledge in the art to which the present disclosure belongs of the scope of the present disclosure, and the present disclosure is defined only by the scope of the claims.

In addition, in describing the present disclosure, when it is determined that related known technologies and the like may obfuscate the gist of the present disclosure, a detailed description thereof has been omitted. When a component, device, element, or the like of the present disclosure is described as having a purpose or performing an operation, function, or the like, the component, device, or element should be considered herein as being “configured to” meet that purpose or to perform that operation or function.

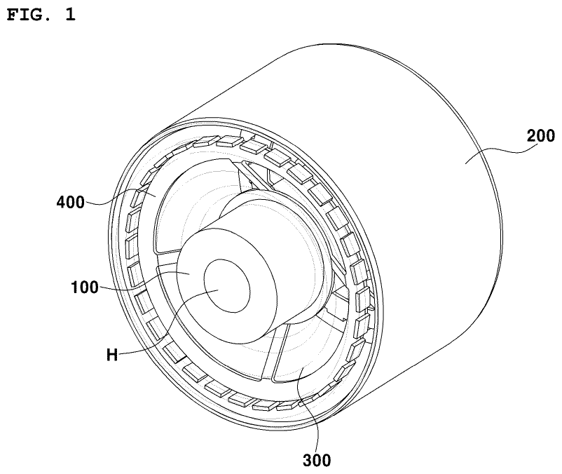

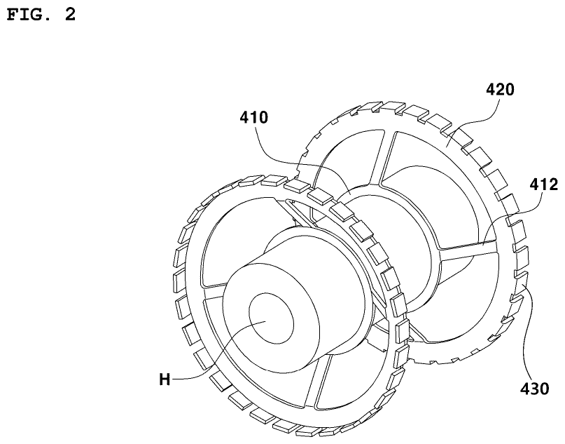

FIG. 1 is a view showing a motor mount for an electric vehicle according to an embodiment of the present disclosure, and FIG. 2 is a view showing a flap damper for the motor mount for an electric vehicle according to the embodiment of the present disclosure.

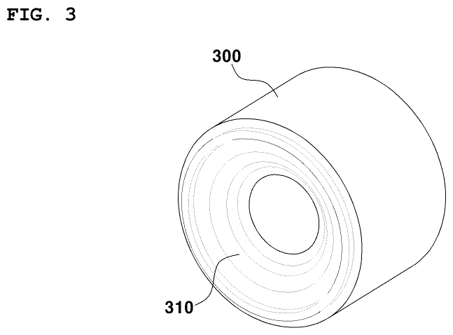

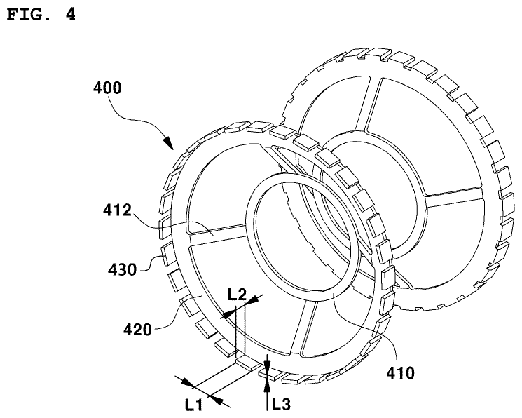

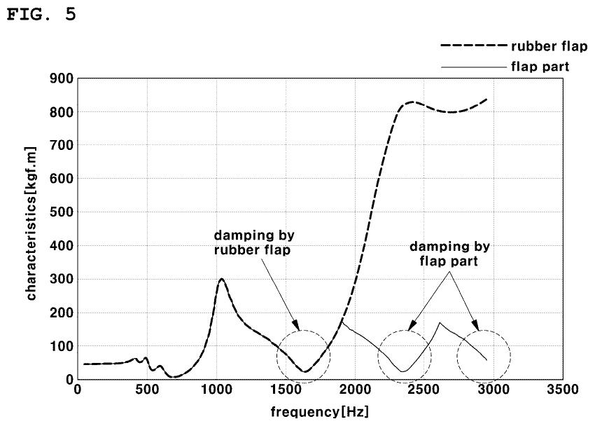

In addition, FIG. 3 is a view showing an insulator for the motor mount for an electric vehicle according to the embodiment of the present disclosure, FIG. 4 is a view showing a flap part for the motor mount for an electric vehicle according to the embodiment of the present disclosure, and FIG. 5 is a graph showing vibration reduction in a high-frequency band (e.g., a target frequency band) by the motor mount of an electric vehicle according to the embodiment of the present disclosure.

According to one embodiment of the present disclosure, referring to FIG. 1, the motor mount for an electric vehicle includes: an inner pipe 100, an outer pipe 200, an insulator 300, and a flap damper 400.

The inner pipe 100 has a fastening hole “H” provided on its inner side and is configured to be fastened to a load input point of a vehicle body.

In other words, the inner pipe 100 may be fastened to the vehicle body and, more specifically, to the load input point of the motor module, through fastening methods such as bolting and the like to the fastening hole H and may behave or vibrate integrally with the motor module accordingly.

The outer pipe 200 is provided to have a larger diameter than the inner pipe 100 and is arranged coaxially with the inner pipe 100 on the outer side of the inner pipe 100.

Here, the outer pipe 200 may be coupled to the vehicle body through a bracket (not shown) or the like and, for example, may be coupled to the vehicle body in a state of being press-fitted to the inner side of the bracket.

In addition, as shown in FIG. 3, the insulator 300 is molded and coupled between the inner pipe 100 and the outer pipe 200 and thus is provided to reduce vibration transmitted through the inner pipe 100.

More specifically, the insulator 300 may be molded by injecting rubber resin into an area between the inner pipe 100 and the outer pipe 200, and at this time, the insulator 300 may be coupled with an outer circumferential surface of the inner pipe 100 and an inner circumferential surface of the outer pipe 200.

The insulator 300 like this may be integrally equipped with a rubber flap 310 to secure insulation performance against low/medium/high-frequency (1000 Hz or less) vibrations (see FIG. 3).

Such rubber flaps 310 are integrally provided to protrude at opposite ends along the axial direction of the insulator 300, respectively, and are configured to reduce vibration transmitted to the insulator 300 through the inner pipe 100.

The rubber flap 310 may protrude in a flap shape from the axial end of the insulator 300 and extend in a circumferential direction. Furthermore, the rubber flap 310 may feature a band-shaped protrusion extending in the circumferential direction from the axial end of the insulator 300.

Here, the rubber flap 310 is arranged coaxially with the inner pipe 100 and the insulator 300.

The rubber flap 310 may be provided in a circular shape by extending in the circumferential direction as described above, but this is only for one embodiment and is not fixed. For example, the rubber flap 310 may even be provided in a semicircular shape, where one side in the circumferential direction is severed.

Through this structure, the rubber flap 310 may absorb the vibration of the insulator 300 by being elastically deformed when vibration is applied to the insulator 300 and reduce not only low/medium-frequencies but also the natural frequency in the high-frequency range of 1000 Hz or less.

For example, as shown in FIG. 3, the rubber flap 310 may be provided to protrude at a portion recessed from the surface at the axial end of the insulator 300.

As shown in FIGS. 1 and 2, the flap damper 400 is fixed to the inner side of the insulator 300 and coupled to the inner pipe 100 such that the flap damper 400 reduces the vibration, within a set target high-frequency band, transmitted through the inner pipe 100.

Furthermore, the flap damper 400 is configured to reduce the vibration within a set target ultra-high-frequency band, which exceeds the high-frequency band reduced through the rubber flap 310.

In other words, it may be effective in improving the vibration reduction performance of the vehicle's low/medium/high-frequency bands (1000 Hz or less) by applying the aforementioned rubber flap 310. However, in the case of an ultra-high-frequency band of 1500 Hz or higher, it is inevitable to encounter difficulty in improving the vibration reduction performance by using only the rubber flap 310 (see FIG. 5).

Recently, development of vehicles such as Battery Electric Vehicles (BEVs), Fuel Cell Electric Vehicles (FCEVs), and the like applied with motors/reducers has become widespread, and as the structure of motors/reducers has become increasingly complex, and the number of gears has increased accordingly, it is desired to improve the reduction of vibration, whine noise, and the like in multiple high-frequency bands.

Accordingly, the motor mount for an electric vehicle, according to the present embodiment, may be configured to include the flap damper 400 made of a high-strength material such as steel, aluminum, plastic, or the like, thereby enabling the reduction of vibration in an ultra-high-frequency band, which exceeds 1000 Hz.

To this end, the flap damper 400 is provided with a coupling part 410, a supporting part 420, and a flap part 430.

The coupling part 410 is provided in a ring shape corresponding to the outer diameter of the inner pipe 100 and is coupled to the outer circumferential surface of the inner pipe 100.

The supporting part 420 extends from the coupling part 410 to an axial end portion of the insulator 300, extending radially from the coupling part 410 through a plurality of the connecting members 412. The supporting part 420 may be provided in a ring shape relatively larger than the coupling part 410.

In other words, as shown in FIG. 2, the supporting part 420 may extend in a circumferential direction, being provided at the axial end portion of the insulator 300. Furthermore, the supporting part 420 may be disposed to face the rubber flap 310.

The flap part 430 is provided with a plurality flaps protruding along the circumferential direction of the supporting part 420 and is arranged coaxially with the inner pipe 100 and the insulator 300 in the same manner as the rubber flap 310.

Such a flap part 430 is provided to absorb the vibration of the insulator 300 by providing a damping effect through natural frequency reduction by being elastically deformed when vibration is applied to the insulator 300.

As shown in FIG. 4, such a flap part 430 may correspond to a target high-frequency band and be provided to adjust (tune) a length L1 in a width direction, a length L2 in a height direction, and a thickness L3.

For example, in the case where the vibration in the target high-frequency band exceeding 2500 Hz is to be reduced, by adjusting (tuning) the length L1 in the width direction and the length L2 in the height direction to be shorter, while increasing the thickness L3, the flap part 430 may effectively reduce the vibration in the corresponding target high-frequency band by overlapping the natural frequency of the insulator 300.

On the contrary, in the case where the vibration in the target high-frequency band exceeding 2000 Hz is to be reduced, by adjusting (tuning) such that, compared with the target high-frequency band exceeding 2500 Hz described above, the length L1 in the width direction and the length L2 in the height direction are longer while the thickness L3 is thinner, the flap parts 430 may effectively reduce the vibration in the corresponding target high-frequency band by overlapping the natural frequency of the insulator 300.

Here, the flap part 430 may be provided with the plurality of flaps, each of which has a length L1 in the width direction identical to one another, a length L2 in the height direction identical to one another, and a thickness L3 identical to one another. In one embodiment, each of the plurality of flaps may protrude along the axial direction. In another embodiment, the flap part 430 may also be provided with a plurality of flaps, each of which has a length L1 in the width direction different from one another, a length L2 in the height direction different from one another, and a thickness L3 different from one another, and be provided to protrude along the axial direction.

In other words, the flap part 430 may be provided with a plurality of flaps, each of which has a length L1 in the width direction complexly different from one another, a length L2 in the height direction complexly different from one another, and a thickness L3 complexly different from one another, and be provided to protrude along the axial direction. As a result, each of the plurality of flaps may create a different natural frequency, thereby allowing different target high-frequency band vibrations to be effectively reduced.

In addition, the flap part 430 may control the damping amount by adjusting (tuning) the number of flaps protruding from the supporting part 420.

Accordingly, the flap part 430, according to the present embodiment, may be configured to implement multi-section damping and the damping amount adjustment in a complex manner, by adjusting (tuning) the number of the flaps as well as the length L1 in the width direction, the length L2 in the height direction, and the thickness L3, for each of the flaps.

As a result, in the present embodiment, issues such as whine noise caused by vibration noise in the low/medium/high-frequency bands may be addressed through the insulator 300 including the rubber flap 310, and issues such as whine noise caused by vibration noise in the target high-frequency band of the ultra-high-frequency band may be addressed through the flap parts 430.

The present disclosure may improve damping performance in a high-frequency band of 1000 Hz or higher by adding a flap part made of a high-strength material such as steel, aluminum, plastic, or the like and may have an effect that provides a damping effect at a specific frequency through tuning by selectively adjusting the number of flaps along with the thickness, length, and width of the flaps constituting the flap part, and that allows the damping amount to be adjusted simultaneously.

In addition, the present disclosure may have the effect of creating multiple natural frequencies and implementing multi-section damping by configuring the motor mount by applying a plurality of flaps, each of which has a thickness different from one another, a length different from one another, and a width different from one another, together to a single flap part.

Although the present disclosure has been described above with reference to the embodiment(s) shown in the drawings, these are merely exemplary, and those having ordinary skill in the art should understand that various modifications may be made therefrom, and that all or part of the embodiment(s) described above may even be selectively combined and configured.

What is claimed is:

1. A motor mount for an electric vehicle, the motor mount comprising:
an inner pipe having a fastening hole provided on an inner side and configured to be fastened to a load input point of a vehicle body;
an outer pipe configured to be arranged coaxially with the inner pipe on an outer side of the inner pipe;
an insulator configured to be coupled between the inner pipe and the outer pipe and provided with a rubber flap configured to reduce vibration transmitted through the inner pipe; and
a pair of flap dampers fixedly coupled to an inside of the insulator and configured to reduce vibration in a set target high-frequency band transmitted through the inner pipe.

2. The motor mount of claim 1, wherein the pair of flap dampers is configured to reduce vibration in the set target high-frequency band set to exceed the vibration in a high-frequency band being reduced through the rubber flap.

3. The motor mount of claim 1, wherein each flap damper of the pair of flap dampers comprises:
a coupling part in a ring shape configured to be coupled with an outer circumferential surface of the inner pipe;
a supporting part extending from the coupling part to an axial end of the insulator; and
a flap part provided with a plurality of flaps protruding along a circumferential direction of the supporting part.

4. The motor mount of claim 3, wherein: the supporting part is provided in a ring shape with a plurality of connecting members extending radially from the coupling part, and
the flap part is configured to face the rubber flap and protrude from the supporting part.

5. The motor mount of claim 3, wherein the flap part is configured to correspond to the set target high-frequency band by adjusting a length in a width direction, a length in a height direction, and a thickness of the plurality of flaps.

6. The motor mount of claim 3, wherein flaps of the plurality of flaps have a length in a width direction identical to one another, a length in a height direction identical to one another, and a thickness identical to one another.

7. The motor mount of claim 3, wherein flaps of the plurality of flaps have a length in a width direction different from one another, a length in a height direction different from one another, and a thickness different from one another.

8. The motor mount of claim 3, wherein the flap part is configured to set a damping amount by adjusting a number of the plurality of flaps protruding from the supporting part.
